(19) United States
(12) Patent Application Publication
(10) Pub. No.: US 2011/0031714 A1
(43) Pub. Date: Feb. 10, 2011

(54) Hand driven scooter

(76) Inventors: Eddie S. Massey, Santa Monica, CA (US); Samuel Levy, Laguna Woods, CA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/461,359

(22) Filed: Aug. 10, 2009

(51) Int. Cl. B62M 1/14

(52) U.S. Cl. 280/221

(57) ABSTRACT

An improved portable hand powered scooter and method of operating the same is disclosed in which the rider's hands move in unison to propel the scooter forward and to steer. The scooter is slowed and stopped when the rider reverses the hand rotation. The scooter is propelled, directed, slowed and stopped using the rider's hands and is thus suited for use by those with limited lower body mobility. The drive mechanism includes a hinge assembly that permits the steering column/drive system to fold back on the scooter so as to reduce the scooter's overall height and increase the scooter's portability.

### FIELD OF THE INVENTION

The present invention relates to the field of collapsible wheeled vehicles and in particular to portable collapsible scooters that are powered by hand and can be operated by those with limited lower body mobility.

There is a need for a hand powered wheeled vehicle that can be used by individuals with limited lower body mobility. Traditional bikes and scooters are typically leg and foot driven. For those with limited lower body mobility, such leg and foot driven wheeled vehicles are not a viable option. Of course, such individual may still enjoy the opportunity to use a wheeled vehicle.

Hand powered mobile devices, such as hand-powered railway carts, have been known for years. But the railway carts are large and cumbersome, and are operated on rails by raising and lowering a pivot bar. These devices are not readily portable and they are not suitable for use on the street for recreation, exercise or transportation by those with limited lower body mobility.

More recently, two wheeled scooters such as those shown U.S. Pat. No. 6,708,997 to Chait have been described. Such scooters, though less reliant on lower body mobility, utilize a back and forth arm motion to drive the vehicle, cannot be folded to promote portability, and fail to disclose mechanisms to slow, stop, or turn the vehicle. Such devices have not disclosed any way to change the drive gear ratios while the vehicle is moving to vary the mechanical advantage provided.

### SUMMARY OF THE INVENTION

It is an object of the present invention to provide a new and improved portable collapsible scooter that is powered by hand and overcomes the limitations found in the known scooters. The present invention achieves this goal by providing a scooter which is driven by hand using a motion in which both hands simultaneously move a peddle assembly mounted to a steering column in counterclock-wise rotation to drive the scooter and counterclock-wise to slow or stop the scooter or rotate both hands to the right or to the left to turn the drive wheel and thus steer the scooter.

To promote portability, the present invention introduces a hinge which allows the steering column to fold back towards the scooter frame. This unique hinge also allows for adjustment of the axle height to adjust for users of different height.

It is a further object of the present invention is to provide a hand-powered scooter that includes a way to vary the mechanical advantage being applied to the drive wheel while the scooter is moving. The transmission from one level of mechanical advantage serves to allow the operator to change gears making hill ascent easier.

Yet another important object of the present invention is to provide a method by which users having limited lower body mobility can propel, or slow, a scooter using a crank shaft mounted to the axle used to turn the scooter. The gear change device is located in the right handle of the crank. All functions, therefore, can be selected without releasing the crank creating a simple and safe method of operation.

### DESCRIPTION OF THE DRAWINGS

FIG. 1 is a side view of the hand driven scooter showing the steering column in two different positions.

FIG. 2 is a partial cross-sectional view of the steering column hinge of the hand driven scooter showing the position of the gearbox and the double intermediate sprocket.

FIG. 3 is a top view of the of the hand driven scooter.

FIG. 4. is partial side view of the steering column hinge of the hand driven scooter showing the pin location and additional holes for adjustment.

### DETAILED DESCRIPTION OF THE INVENTION

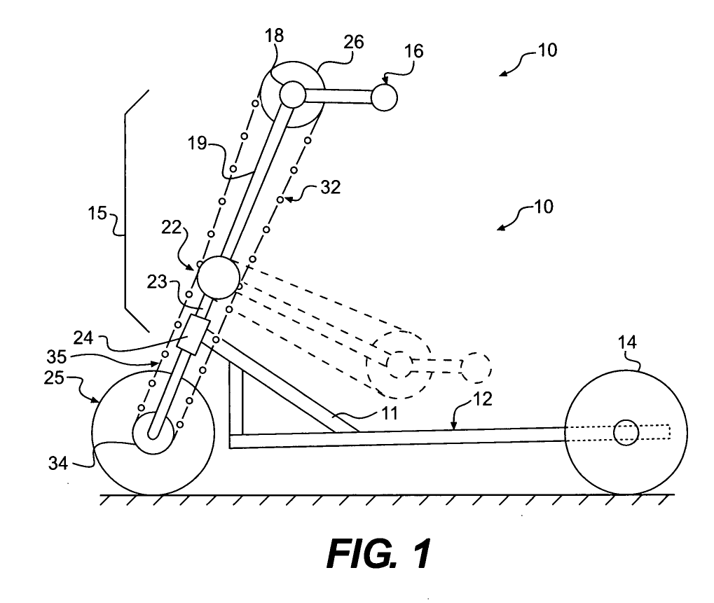

Referring to FIGS. 1-4, the preferred embodiment of the portable hand driven scooter 10 is shown. The frame 11 provides a standing platform 12 for the user and is supported at one end by two rear wheels 13 and 14, which are rotatably attached to frame 11. The frame 11 of the preferred embodiment is fabricated from metal tubing and covered with a wood or metal platform 12. Because the invention is directed to those with limited lower body mobility, the preferred embodiment uses two rear wheels to provide greater balance and stability. The invention, however, could also be executed with just one rear wheel.

The steering assembly 15 includes handlebars 16, which also serve as the crank shaft to propel the portable hand driven scooter 10 of the present invention. The handlebars 16 are rotatably mounted to a collar 18 mounted to the top of a tube serving as an upper steering column 19. The upper steering column 19 is secured to an upper hinge plate 20. Upper hinge plate 20 is rotatably connected to lower hinge plate 21. The upper hinge plate 20 and lower hinge plate 20, which together form hinge 22, can be rotated and secured in relative angular position, to adapt the scooter 10 to account for varying heights of riders and to fold the upper steering column 19 back towards the standing platform 12 for ease of storage and transportation as shown in FIG. 1 (dotted lines). In the preferred embodiment, the upper steering column 19 is formed of a generally cylindrical hollow metal tube.

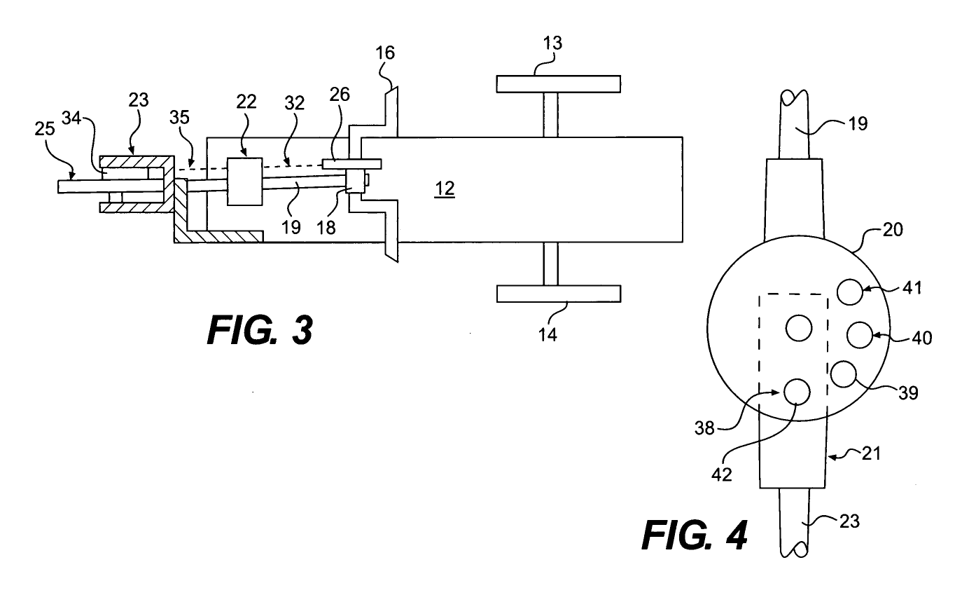

The steering assembly 15 also includes a lower steering column 23. Lower steering column 23 attaches at one end to lower hinge plate 21, passes through a collar 24 mounted on frame 11, and includes a drive wheel 25 assembly rotatably mounted at a lower end. In the preferred embodiment, the lower steering column 23 is formed of a generally cylindrical hollow metal tube where it is attached to the lower hinge plate 21 and passes through the collar of frame 11, but is formed in a fork-shape such that the drive wheel assembly 25 is mounted between the forks of the lower steering column 23. The bicycle fork of lower steering column 23 are best shown in FIG. 3. The lower end of the steering column 23 to which drive wheel 25 is mounted may also be formed, for example, of a generally cylindrical hollow metal tube.

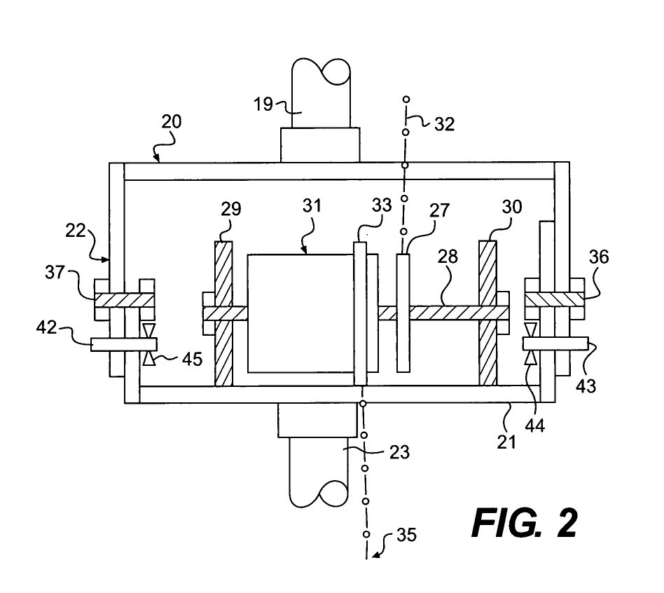

To propel the portable hand driven scooter 10, a drive sprocket 26 is fixedly mounted to the handlebars 16 which serve as the crank shaft. As shown in FIG. 2, a second sprocket 27 is mounted to a drive axle 28 which is mounted to lower hinge plate 21 through axle supports 29 and 30 such that the second sprocket 27, and the drive axle 28 to which it is mounted, are capable of rotation within the hinge 22. As shown in FIG. 2, hinge 22 formed of upper hinge plate 20 and lower hinge plate 21 also houses a double sprocket gearbox 31 mounted to drive axle 28. A first drive chain 32 operatively connects drive sprocket 26 mounted to handlebars 16 and second sprocket 27. Also shown in FIG. 2 is sprocket 33 which is disposed within hinge 22 and fixedly mounted to drive axle 28. As shown in FIGS. 3 and 4, sprocket 34 is mounted to having drive wheel assembly 25, which assembly incorporates a conventional coaster brake. Drive chain 35 operatively connects sprocket 33 with sprocket 34.

In operation, the rider of the portable hand driven scooter 10 both steers and drives via handlebars 16. As with a normal bike, the rider controls the direction of travel by rotating the handlebars 16, and thus the steering assembly 15, in the chosen direction. To drive the scooter 10, the rider rotates handlebars 16 in the counterclockwise direction as viewed in FIG. 1. Given the generally “U-shaped” construction of the handlebars 16 (as best seen in FIG. 3), it should be understood that the rider's hands rotate handlebars 16 in unison, with both hand moving forward/down/back/up in unison. This drive movement facilitates conversion of the driver's weight into drive power as the user shift his weight back and forth. Because the user and convert his back and forth movement into drive power, less upper body strength and exertion is required to propel the scooter 10.

The clockwise rotation of handlebars 16 causes drive sprocket 26 to rotate, which through chain 32 causes sprocket 27 to rotate. Because sprocket 27 is mounted on the drive axle 28 of conventional bicycle gearbox 31, which includes driven sprocket 33, rotation of sprocket 27 causes rotation of driven sprocket 33. In turn, rotation of sprocket 33, which operatively connected to sprocket 34 through chain 35, causes rotation of sprocket 34 and the attached drive wheel 25. To brake, the user reverses the direction of rotation and the coaster brake within drive wheel assembly 25 causes scooter 10 to slow and to stop. Optionally, this braking can be augmented by a hand or foot operated brake (not shown) operating on either wheel assembly 25 or rear wheels 13, 14.

The construction of hinge 22, in combination with the unique drive system comprised of two chains and four sprockets facilitates transportation by allowing scooter 10 to fold into a more compact form. This same construction also enables scooter 10 to be adjusted to account for variations of rider height. The rotational adjustment of hinge 22 is discussed in connection with FIGS. 2 and 4. As seen in these figures, upper hinge plate 20 and lower hinge plate 21 are rotatably connected through fasteners 36 and 37. In the preferred embodiment, bolts are used as these fasteners. Upper hinge plate 20 is provided with holes 38, 39, 40, and 41 through which pin 42 can be inserted. The lower hinge plate is provided with a corresponding hole (not shown) which is also adapted to receive pin 42. The angular adjustment of steering assembly 15 is accomplished by removing pin 42, rotating the upper steering column 19 until the desired angle is reached and one of holes 38, 39, 40, or 41 of the upper hinge plate 20 aligns with a corresponding hole in lower hinge plate 21 (not shown), and inserting pin 42. Pin 42 may be manual or spring loaded, and two pins 42 and 43 are used on opposite sides of hinge 22. In the presently preferred embodiment, bolts may be used for pins 42 and 43, which bolts fit through holes 38, 39, 40 or 41, through the corresponding hole in lower hinge plate 21 and secured by a wingnuts 44, 45.

Moreover, in the preferred embodiment, the portable hand driven scooter 10 is equipped with a conventional, off-the-shelf, bicycle gearbox 31. The gearbox 31 of the preferred embodiment is of the double sprocket type and can provide 3 different final drive gear ratios so as to enable the rider to change the mechanical leverage needed to drive scooter 10 up an incline. Gearbox 31 can be activated and controlled by a gear selector (not shown) mounted on steering assembly 15.

While the invention has been shown and described by reference to the presently preferred embodiments, it should be understood that changes in the structure, materials and form may be made by those of skill in the art without departing from the invention.

What is claimed is:

1. A portable hand driven scooter comprising:
a frame having a front and a rear and a support platform to support a standing user;
at least one rear wheel rotatably mounted to the rear of the frame;
a foldable steering assembly having at first and a second tube, said foldable steering assembly being rotatably mounted to the front of the frame, said foldable steering assembly further including a tube and a fork assembly, wherein said tube and said fork assembly each have an upper end and a lower end;
a crank shaft rotatably mounted to said upper end of said foldable steering assembly first tube, said crank shaft having at least three portions, a right hand portion, a left hand portion, and a generally U-shaped intermediate portion connecting the right and left hand portions, said right and left hand potions being generally co-linear;
a front wheel rotatably mounted to said lower end of said foldable steering assembly fork assembly;
a hinge assembly having an upper part fixedly secured to said lower end of said foldable steering assembly first tube, a lower part fixedly secured to said upper end of said foldable steering assembly second tube, the upper and lower parts of the hinge assembly being rotatably connected so as to facilitate angular adjustment of the first tube of the foldable steering assembly relative to the second tube of said steering assembly, said hinge assembly further including a lock for selectively securing said hinge upper part and hinge lower part in one of a plurality of angular positions; and
a drive system comprising
a first drive gear mounted to said intermediate portion of said hand driven crank,
a second drive gear mounted to a drive shaft rotatably secured to said hinge assembly,
a third drive gear mounted to said drive shaft, said third drive gear rotating with said second drive gear,
a fourth drive gear mounted to said front wheel,
a first drive chain operatively connecting said first drive gear to said second drive gear, and
a second drive chain operatively connecting said third drive gear and said fourth drive gear;
wherein said counter-clockwise rotation of the hand driven crank shaft causes said front wheel to propel said portable hand driven scooter forward.

2. The portable hand driven scooter of claim 1, wherein the drive system includes a gearbox mounted to said drive shaft and operatively connecting said second drive gear and said third drive gear through which said user can select between a plurality of gear ratios.

3. A method of operating a portable scooter using an operator's hands comprising the steps of:
providing a frame having a front and a rear and a support platform to support a standing user;
providing at least one rear wheel rotatably mounted to the rear of the frame;
providing a foldable steering assembly having at first and a second tube, said foldable steering assembly being rotatably mounted to the front of the frame, said foldable steering assembly further including a tube and a fork assembly, wherein said tube and said fork assembly each have an upper end and a lower end;
providing a crank shaft rotatably mounted to said upper end of said foldable steering assembly first tube, said crank shaft having at least three portions, a right hand portion, a left hand portion, and a generally U-shaped intermediate portion connecting the right and left hand portions, said right and left hand potions being generally co-linear;
providing a front wheel rotatably mounted to said lower end of said foldable steering assembly fork assembly;
providing a hinge assembly having an upper part fixedly secured to said lower end of said foldable steering assembly first tube, a lower part fixedly secured to said upper end of said foldable steering assembly second tube, the upper and lower parts of the hinge assembly being rotatably connected so as to facilitate angular adjustment of the first tube of the foldable steering assembly relative to the second tube of said steering assembly, said hinge assembly further including a lock for selectively securing said hinge upper part and hinge lower part in one or a plurality of angular positions; and
providing a drive system comprising
a first drive gear mounted to said intermediate portion of said hand driven crank,
a second drive gear mounted to a drive shaft rotatably secured to said hinge assembly,
a third drive gear mounted to said drive shaft, said third drive gear rotating with said second drive gear,
a fourth drive gear mounted to said front wheel,
a first drive chain operatively connecting said first drive gear to said second drive gear, and
providing a second drive chain operatively connecting said third drive gear and said fourth drive gear;
standing on said support platform;
gripping said right hand portion of said crank shaft with a right hand and gripping said left hand portion of said crank shaft with a left hand;
propelling said scooter forward by moving said right and left hand in unison so as to rotate said crank shaft and transmit power through said drive system to drive said front wheel; and
steering said scooter by moving said right and left hands so as to rotate said crank shaft and re-direct said front wheel.
